(19) United States
(12) Patent Application Publication
(10) Pub. No.: US 2026/0048346 A1
(43) Pub. Date: Feb. 19, 2026

(54) FLUID STRAINER

(71) Applicant: Paul F. Nehlen, III, Delavan, WI (US)

(72) Inventor: Paul F. Nehlen, III, Delavan, WI (US)

(73) Assignee: Blue Skies Global LLC, Williams Bay, WI (US)

(21) Appl. No.: 19/369,849

(22) Filed: Oct. 27, 2025

Related U.S. Application Data
(63) Continuation-in-part of application No. 19/307,714, filed on Aug. 22, 2025.
Application No. 19/307,714 is a continuation-in-part of application No. 18/389,978, filed on Dec. 20, 2023.
(60) Provisional application No. 63/435,018, filed on Dec. 23, 2022.

(51) Int. Cl. B01D 29/33; B01D 29/92; B01D 35/30

(52) U.S. Cl. CPC B01D 29/33; B01D 29/92; B01D 35/30; B01D 2201/345; B01D 2201/40

(57) ABSTRACT

A fluid strainer that is meant to remove debris from a fluid stream and including a housing having in inlet port defined at an inlet wall of the housing and an outlet port that is opposite to the inlet port and that is defined by an outlet wall of the housing; the housing defining an interior chamber through which the fluid flows; a strainer basket that is disposed within the housing chamber; the strainer basket having an open inlet end into which the fluid flows from the housing inlet, opposed sidewalls including a pair of tapered outlet walls that merge and direct the fluid flow to the housing outlet port and an outlet end wall; and a bar that is disposed within the housing that is located adjacent to and across the outlet port for spacing the outlet end wall of the strainer basket from the housing outlet wall.

### CROSS-REFERENCE TO RELATED APPLICATIONS

This application is a continuation-in-part (CIP) of U.S. Ser. No. 19/307,714 which was filed on Aug. 22, 2025 which is a continuation-in-part (CIP) of U.S. Ser. No. 18/389,978 which was filed on Dec. 20, 2023 and which claims priority to U.S. Provisional Patent Application No. 63/435,018 which was filed on Dec. 23, 2022 and each of which is incorporated by reference herein in its entirety. U.S. Pat. No. 11,065,566 issued Jul. 20, 2021 is also incorporated herein by reference in its entirety.

### TECHNICAL FIELD

The present invention relates in general to a fluid strainer which is typically used for removing and straining suspended substances from a fluid flow. More particularly, the present invention relates to a fluid strainer that more effectively controls the flow and minimizes turbulence within the strainer device; and thus within the entire filter system . . .

### BACKGROUND OF THE INVENTION

Reference is made to the earlier filed patent applications on the same subject matter. That subject matter relates to improvements. Moreover, improvements are set forth herein in connection with the following objects. An object of the present invention is to provide an improved strainer that enhances the flow of fluid through the strainer thus minimizing turbulence.

Another object of the present invention is to provide a strainer in which the retaining basket can be engaged in the strainer housing in only one way. This is achieved in accordance with the present invention by providing a novel bar arrangement that is disposed within the housing, that is located adjacent to and across from the outlet port and is for spacing the outlet end wall of the strainer basket from the housing outlet wall.

Another object of the present invention is to provide an improved lid construction that employs a series of swivel clamps for securely fixing the lid to the housing.

Another object of the present invention is to provide for a novel lid construction and one in which there is provided a reinforcing rib on the top surface of the lid that functions, not only for reinforcing the lid, but also functions as a handle for the lid.

### SUMMARY OF THE INVENTION

In accordance with an embodiment of the present invention there is provided a fluid strainer that is meant to remove debris from a fluid stream, comprising: a housing having in inlet port defined at an inlet wall of the housing and an outlet port that is opposite to the inlet port and that is defined by an outlet wall of the housing; said housing defining an interior chamber through which the fluid flows; a strainer basket that is disposed within the housing chamber; said strainer basket having an open inlet end into which the fluid flows from the housing inlet, opposed sidewalls including a pair of tapered outlet walls that merge and direct the fluid flow to the housing outlet port and an outlet end wall; and a bar that is disposed within the housing that is located adjacent to and across the outlet port for spacing the outlet end wall of the strainer basket from the housing outlet wall.

In accordance with other aspects of the present invention the bar also has a pair of legs that support the bar at opposed sides of the outlet port; the outlet end wall has a series of through-holes for the passage of fluid flow; the tapered outlet walls also each include a series of through-holes; each leg of the bar has one end that is secured to the housing outlet wall at opposed respective sides of the outlet port and a free end that extends from the bar and in the direction of the housing inlet wall; the open inlet end of the strainer basket has a width that is greater than a length of the support bar so that the strainer basket can be engaged in the housing only where the open inlet end of the strainer basket is engaged with the inlet port of the housing; the outlet end wall of the strainer basket contacts the support bar leaving a space between the outlet end wall of the strainer basket and an inner surface of the housing outlet wall so as to mitigate against turbulence; the outlet end wall of the strainer basket has a width that is less than the length of the support bar; including a lid over the housing and a series of swivel clamps that secure the lid to the housing; wherein the series of swivel clamps include a plurality of swivel clamps along each of four sides of the housing; including a lid that is disposed over the housing and covering the interior chamber, a series of swivel clamps that secure the lid to the housing, a gasket that is disposed between the housing and the lid and a series of slots in the lid that accommodate selectively a clamp post of each swivel clamp; including a pneumatic apparatus coupled to the interior chamber to provide a firm seal at the gasket; including a reinforcing rib on a top surface of the lid; and wherein the reinforcing rib is comprised of four orthogonal arranged ribs that each have a center opening so that the ribs form a handle for removing the lid.

### BRIEF DESCRIPTION OF THE DRAWINGS

The drawings are provided for the purpose of illustration only and are not intended to define the limits of the disclosure. The foregoing and other objects and advantages of the embodiments described herein will become apparent with reference to the following detailed description when taken in conjunction with the accompanying drawings in which:

FIG. 1A is a top view of the housing;

FIG. 1B depicts the concept of the present invention of sealing the strainer housing without requiring several fasteners;

FIG. 2 is a plan view illustrating the strainer basket;

FIG. 3 illustrates an alternate embodiment of the tapered sidewalls of the basket;

FIG. 4 illustrates a second alternate embodiment of the tapered sidewalls;

FIG. 5 is an exploded perspective view of the strainer of the present invention, and including the strainer housing and basket;

FIG. 6 is a top perspective view of the top of the strainer housing with the basket in place;

FIG. 7 illustrates the underside of the lid with interlock bars disposed in a predetermined pattern;

FIG. 8 is a front perspective view of the same strainer housing;

FIG. 9 is a rear view of the strainer housing showing the lid in place;

FIG. 10A is a fragmentary view showing the tab end slot about to be engaged;

FIG. 10B is a fragmentary view showing the engagement between the tab and

slot;

FIG. 11 is a perspective view of an alternate embodiment of the present invention that employs a side inlet pipe for receiving filtration media;

FIG. 12 is a cross-sectional view taken along line 12-12 of FIG. 11;

FIG. 13 is a plan view of the embodiment of FIG. 11 with the lid partially cut away;

FIG. 14 is a block diagram of the water delivery system;

FIG. 15 is a perspective view of another embodiment of the fluid strainer of the present invention;

FIG. 16 is a fragmentary view showing one of the fasteners with the fastening knob secured in place;

FIG. 17 is a fragmentary perspective and exploded view of FIG. 16;

FIG. 18 is a fragmentary plan view showing the arrangement between the basket and the locating bar;

FIG. 19 is an internal view showing the bar in relationship to the basket; and

FIG. 20 is a perspective view taken from the inlet end of the basket and furthermore illustrating a capture member.

### DETAILED DESCRIPTION

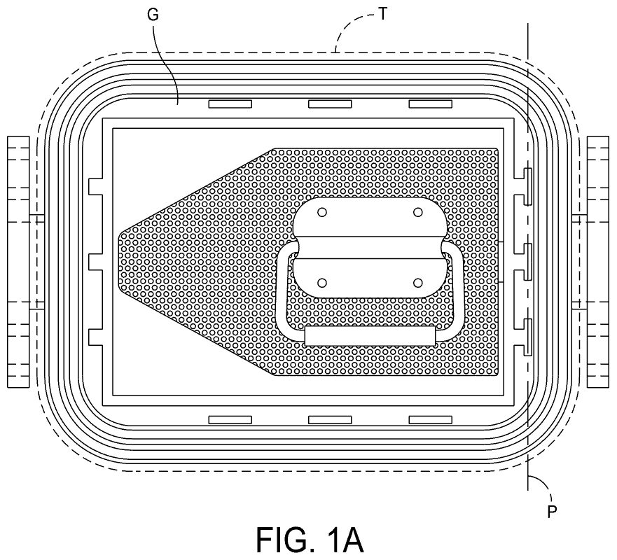

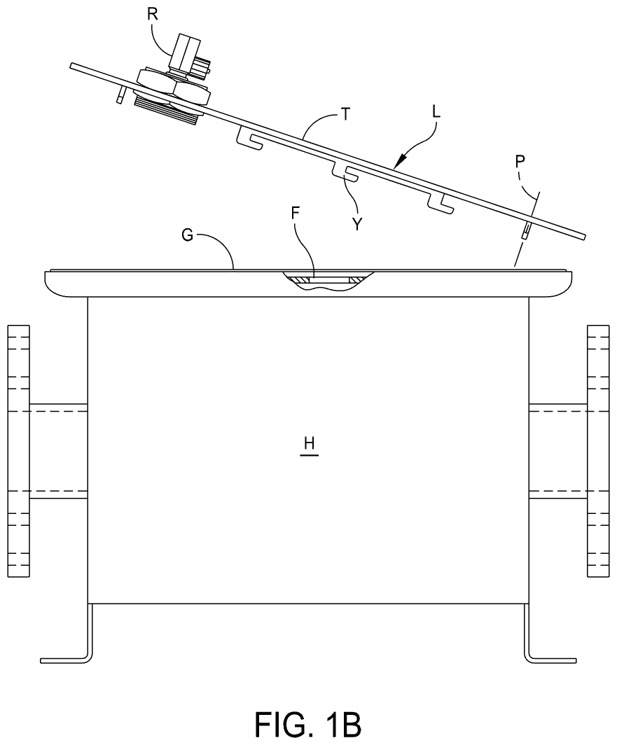

Reference is now made to FIGS. 1A and 1B. As has been indicated, rather than using several securing members to secure the strainer top, the top piece T is meant to slide into a position where it can then be pivoted against the top rim of the chamber and then locked in place. This occurs in a simple one step action without requiring multiple fasteners that have to be unthreaded and rethreaded.

FIG. 1B depicts the concept of the present invention of sealing the strainer housing without requiring several fasteners. FIG. 1A is a top view of FIG. 1B. FIG. 1B shows both the housing H and the lid or cover L. FIG. 1B also illustrates the application of pneumatic force indicated by the input box R. A top piece T that seals the housing is slid into a slot in the cover L. The cover is meant to pivot at point P. FIG. 1B also shows the gasket G. The top piece T is meant to engage against the surface of the gasket G. Refer also to more detailed diagrams in FIGS. 6-9.

Although a pivot arrangement is illustrated in FIG. 1B, in an alternate embodiment of the present invention the cover can be constructed and arranged to be disposed substantially in parallel to the gasket G so that, rather than the pivot mechanism, some type of a slide mechanism is employed to move the cover against and away from the gasket G. In either embodiment it is pneumatic or hydraulic pressure that is employed in moving the cover from an open position to a closed position either by pivoting or a linear transition.

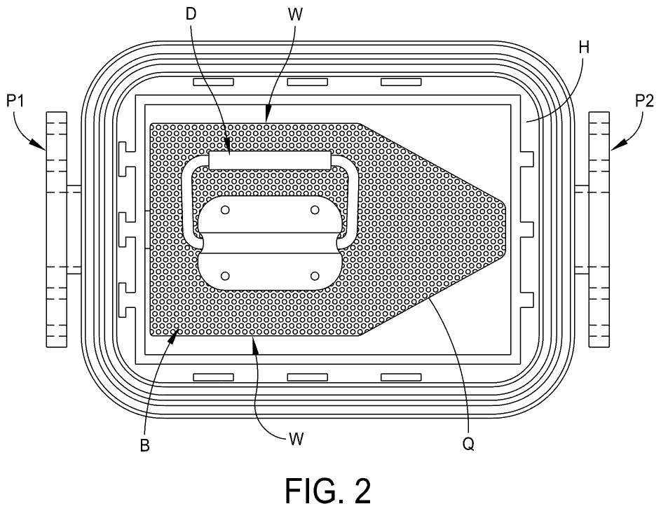

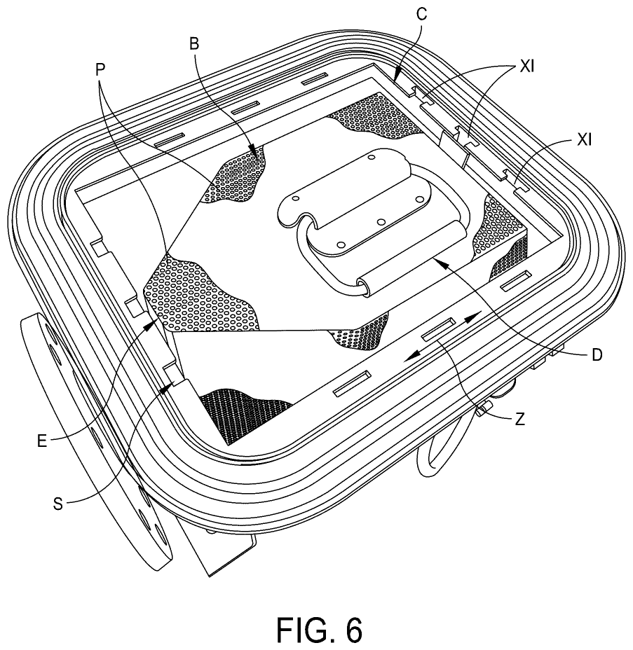

Reference is now made to FIGS. 2-5 to illustrate the construction of the strainer housing; and more particularly, the unique construction of the basket B. In FIGS. 2-5 the housing is shown at H having an inlet port P1 and an outlet port P2. Refer in particular to a more detailed construction in the exploded perspective view of FIG. 5.

The housing H defines an interior chamber through which the fluid flows through the basket B. The strainer basket has an open input end clearly depicted in FIG. 5. In this regard also refer in FIG. 5 to the use of a catcher CA that is meant to intercept certain items; particularly larger size items. The catcher CA is of cross-shape and is disposed at the open input end of the strainer basket; adjacent to the inlet port P1.

The strainer basket also includes opposed sidewalls W that extend generally in the same flow direction of the fluid. It is noted that the sidewalls W are provided with an indentation at M at opposed sides thereof. This indentation is meant to sit upon the ledge LE in the strainer housing as shown in FIG. 5. The strainer basket B further includes an output end depicted in the drawings as an end wall E that is disposed adjacent to the outlet port P2. In FIG. 2 the end wall E is illustrated as spaced from the port P2. However, the end wall E can also be disposed substantially directly at the port P2. Th basket B is also provided with a handle D as illustrate in FIGS. 2 and 5.

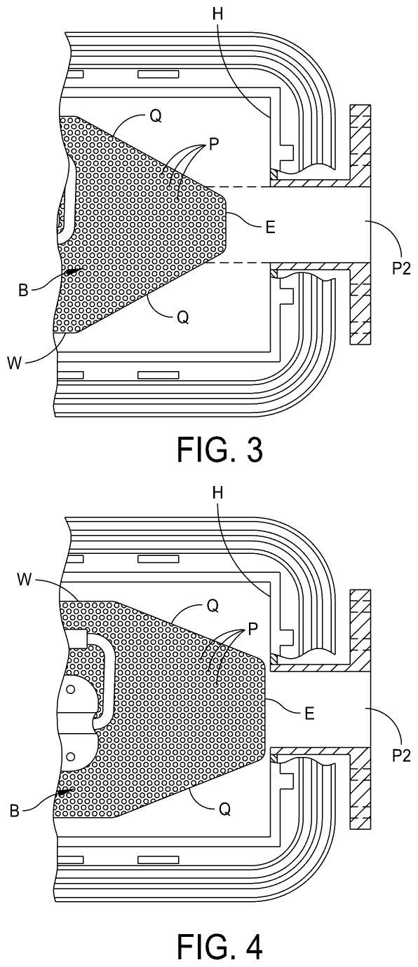

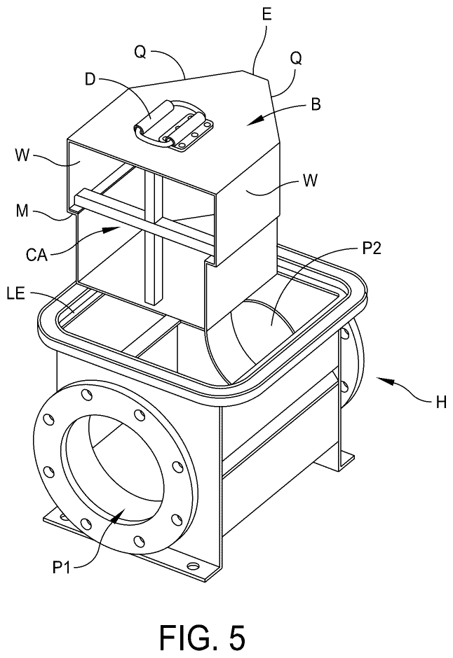

In FIG. 2 the end wall E is smaller than the diameter of the outlet port P2. Reference may now be made to FIGS. 3 and 4 that illustrate different relative dimensions regarding the end wall E and the outlet port P2. FIG. 3 illustrates the end wall E as being substantially the same as the diameter of the port P2. FIG. 4 illustrates the end wall E as being slightly greater than the diameter of the port P2. The sidewalls Q may be solid in construction but are preferably provided with perforations P such as illustrated in FIGS. 3 and 4. The end wall E is provided with perforations that enable the flow to continue to the outlet port P2. The walls Q taper toward the outlet port.

In accordance with one embodiment of the present invention there is provided the combination of using pneumatics; along with a mechanical interlock between the housing and lid. Thus, the strainer includes a mechanical interlock mechanism so that the lid is secured to the housing. The interlock mechanism is operable followed by the operation of the pneumatic apparatus. The mechanical interlock mechanism includes a tab and slot arrangement; wherein the tab and slot arrangement comprises at least one tab on an underside of the lid and at least one slot in the housing. Alternatively, the tab may be provided at the housing end and the slot at the lid end.

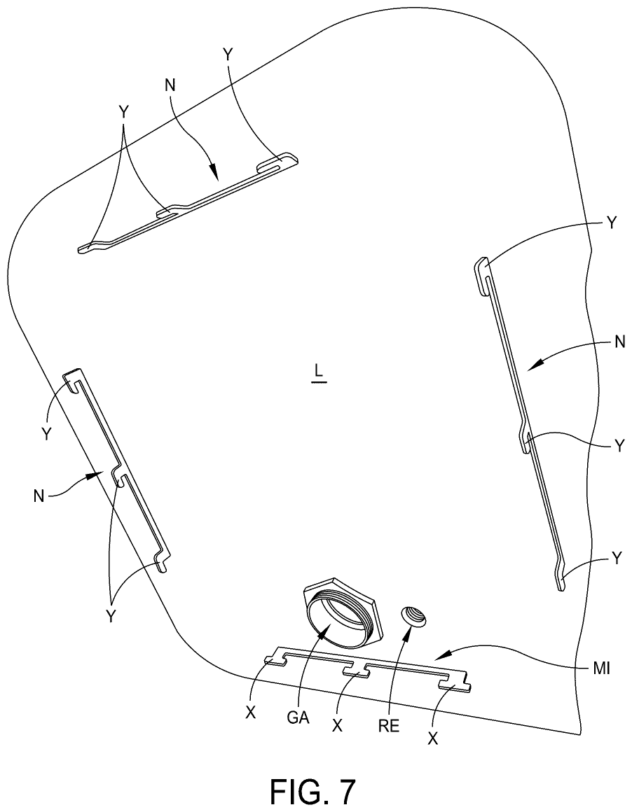

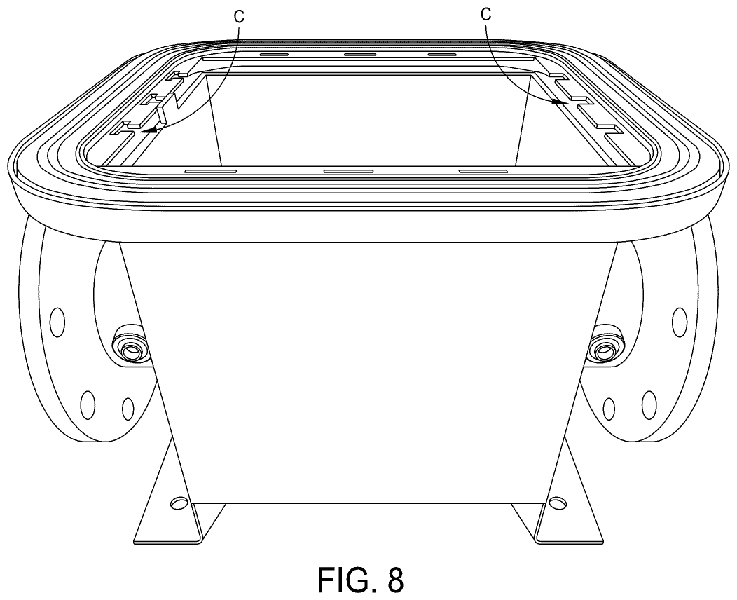

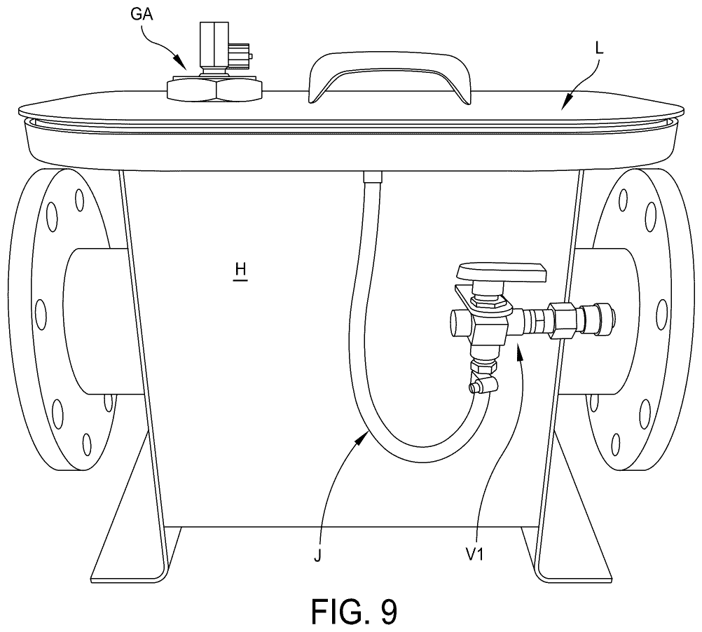

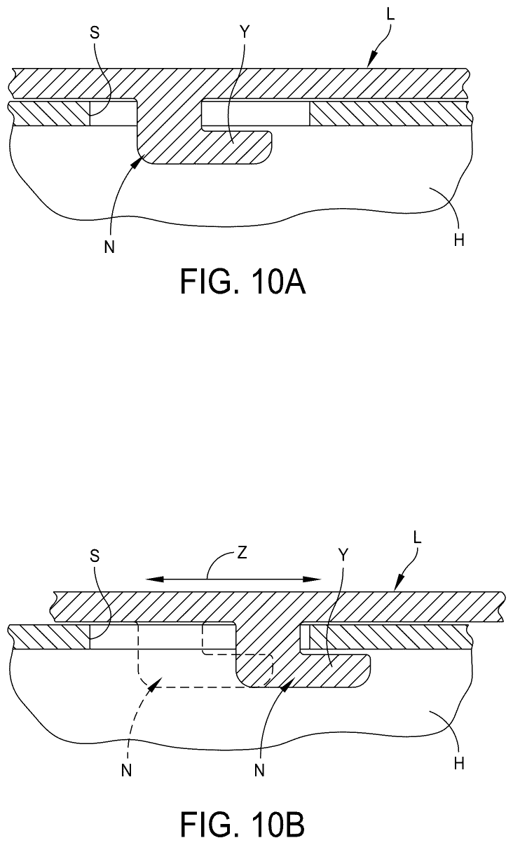

FIG. 6 is a top perspective view of the top of the strainer housing with the basket in place. FIG. 7 illustrates the underside of the lid with interlock bars disposed in a predetermined pattern. FIG. 8 is a front perspective view of the same strainer housing. FIG. 9 is a rear view of the strainer housing showing the lid in place. FIG. 10A is a fragmentary view showing the tab end slot about to be engaged. FIG. 10B is a fragmentary view showing the engagement between the tab and slot so as to provide a positive interlock.

FIGS. 6-9 show various views of the housing H and the lid L. Between those two members, a tab and slot arrangement is used to provide an interlock of the lid to the top of the housing. Refer in particular to FIG. 9 that shows the lid L assembled on the housing H. Regarding the interlocking of the lid with the housing, the underside of the lid has four tab bars N. Refer in particular to FIG. 7 which shows the underside of the lid L. Each of these tab bars has three spaced apart tabs. One of the tab bars identified as bar M1 is provided with T-shaped tabs X. The other three tab bars N each have L-shaped tabs Y.

Reference may now be made to FIG. 6 which shows the slots in the housing. There are provided a series of slots S that are substantially rectangular in shape. At one end of the housing there is provided three T-shaped slots X1. The tabs W illustrated in FIG. 7 are meant to engage with the slots S shown in FIG. 6. At the same time, the tab bar W1 with the T-shaped tabs X are meant for engagement in the slots X1 shown in FIG. 6. The interlocking is provided by moving the lid relative to the housing in the direction of arrow Z in FIG. 6 in order to complete the interlock. FIG. 7 also shows the connection at GA for pneumatic coupling. Also in FIG. 7 RE is directed at a relieve port.

Reference is also made in FIG. 6 to the inclusion of the basket B within the housing. FIG. 6 illustrates the end wall E of the basket B that may be symmetrically aligned with the output port of the housing. In an alternate embodiment of the present invention the end wall E may be slightly off center of the output port of the housing. There are preferably provided perforations P on the top wall of the basket as well as on the end wall. The tapered walls Q may be provided with perforations or may be solid.

Regarding the pneumatic operation, reference may be made to the rear view depicted in FIG. 9. This shows a valve V1. This is the location where the pneumatic pressure is applied. FIG. 9 also shows a hose J that connects the valve V1 into the housing H. This connection couples to the channel C. In this regard refer also to FIGS. 6 and 8 that show the location of an inner channel C where the pneumatic pressure is exerted.

Finally, fragmentary perspective views are illustrated in FIGS. 10A and 10B. FIG. 10A illustrates an initial position of the lid and housing where the tab end slot is about to be engaged. On the other hand, in FIG. 10B the tab is illustrated as engaged with the slot in order to interlock the lid and housing.

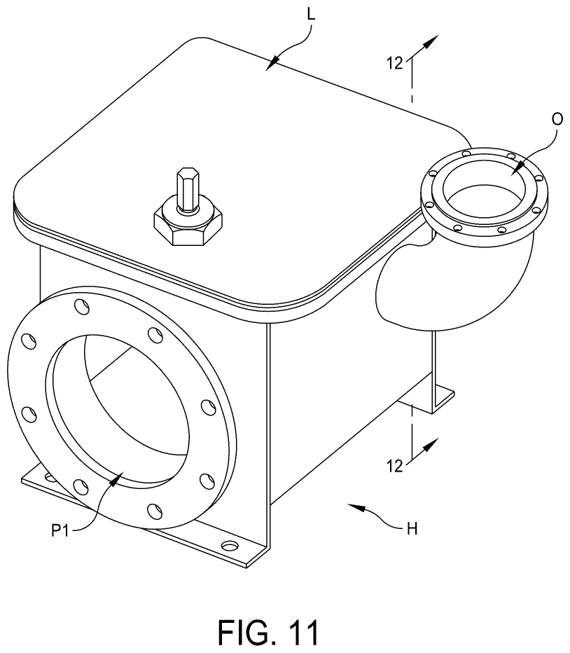

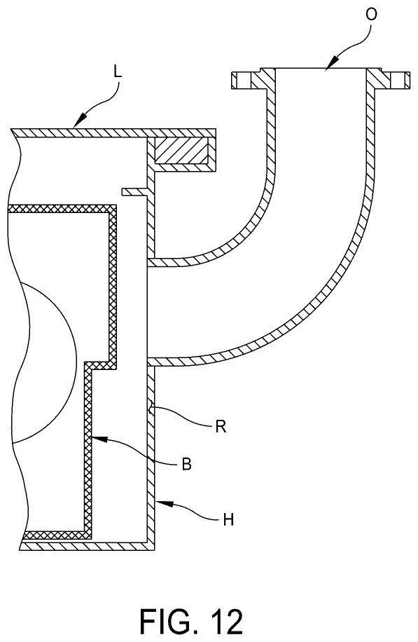

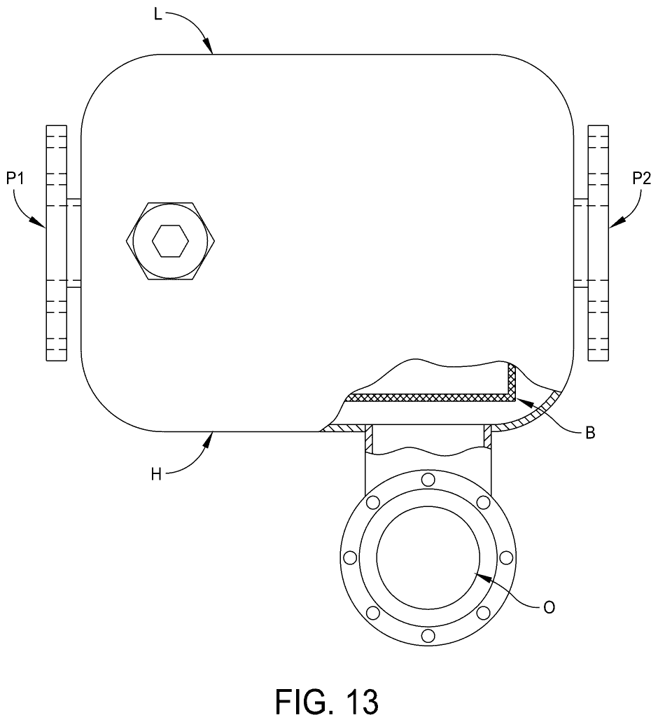

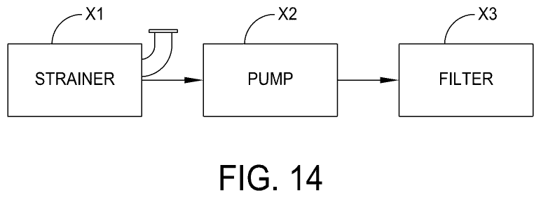

Reference is now made to a further embodiment of the present invention illustrated in FIGS. 11-14. In this embodiment the basic strainer housing H and basket B are substantially the same as described in FIGS. 1-10. This embodiment further adds a side port or pipe O. This side port is for the introduction of filtration media that is to be subsequently deposited on all of the filter elements of the filter array. Regarding the filter element itself, reference can be made to U.S. Pat. No. 11,065,566 which describes the regenerative filter that may be employed from the system of the present invention. In this regard refer also to the block diagram of FIG. 14 that shows the strainer at X1, the pump at X2 and the filter at X3. As noted from FIG. 14 and regarding the direction of flow, the strainer will capture certain contaminants to prevent their entry to the pump X2. The pump X2 then controls the flow to the filter X3.

With further reference to FIGS. 11-13, it is noted that there is a side inlet pipe or port into which the filtration media is deposited. The filtration media may be a diatomaceous earth material, a perlite, and amorphous volcanic glass material or any other appropriate filtration media. As illustrated in the drawings, the pipe O is in a side wall R. By providing the port O at the strainer, this avoids the complexities associated with providing a porting arrangement for introducing the filtration media directly at the filter.

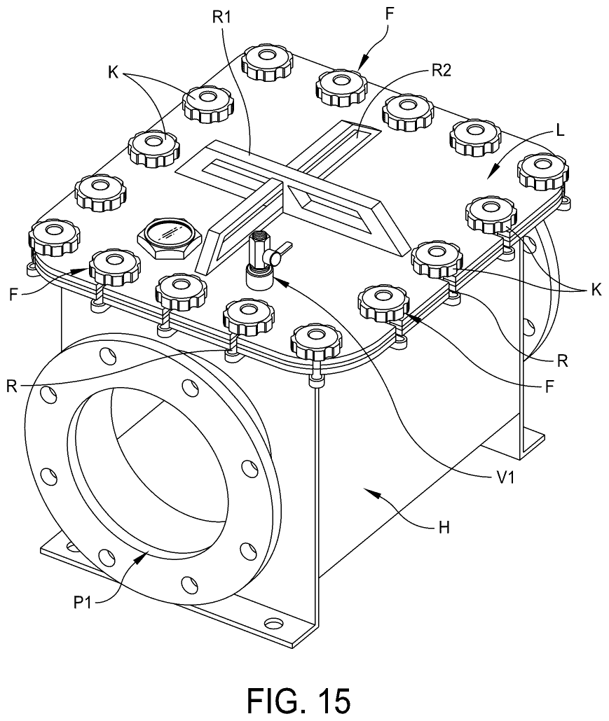

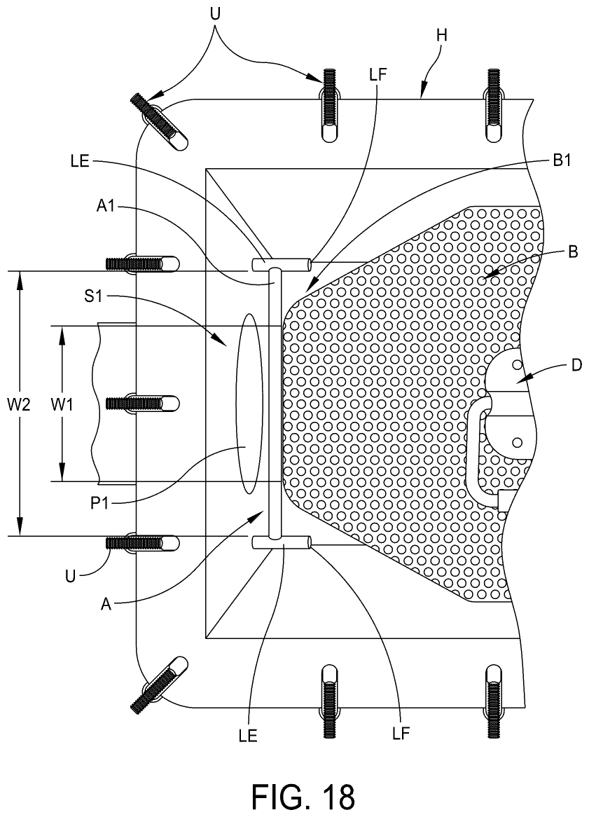

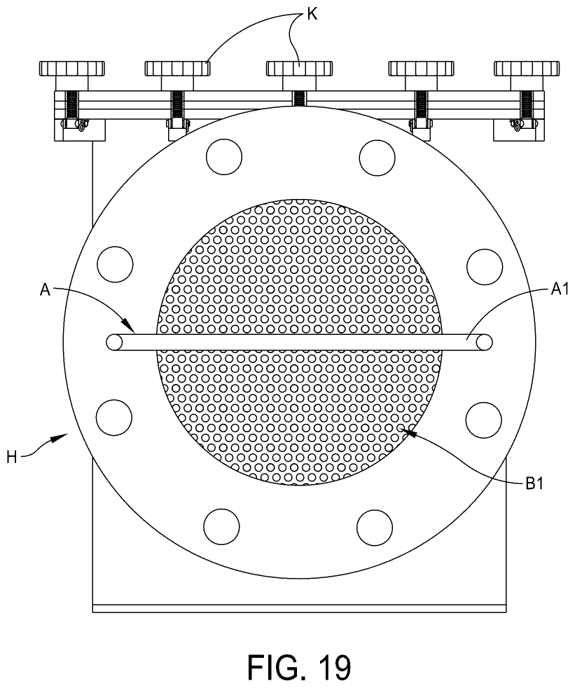

Reference is now made to an alternate embodiment of the present invention that is illustrated in FIGS. 15-20. This embodiment employs multiple different novel features. One of these features relates to the use of multiple fasteners F. Another feature relates to the novel support bar A which is supported from an inner wall of the housing H as shown in FIGS. 18 and 19. Another feature of the present invention is the use of a combination reinforcing bar and handle associated with the lid L.

FIG. 15 illustrates the housing H having an outlet port P1 and a lid L. FIG. 15 shows a plurality of fasteners for securing the lid to an edge EG at the top of the housing. A gasket G is usually provided between the housing and the lid.

FIG. 15 also illustrates the use of a vent at V1. The top wall of the lid L is provided with a reinforcing rib R1. This is in a cross-shape and each of the extensions of the rib is provided with an opening R2. In this way, the reinforcing rib construction is not only to reinforce the strength of the lid L but also functions as a handle for removing the lid L.

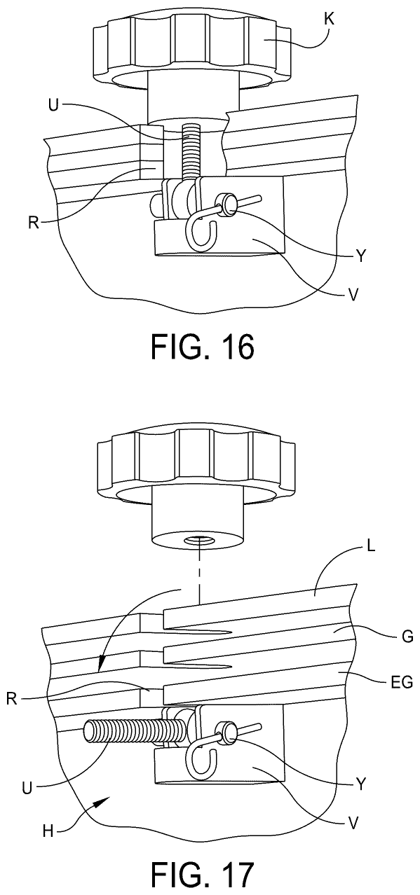

Reference is now made to FIGS. 15 and 17 for further details of the fastener F. The fastener F includes a knob K that can screw onto the bolt U. The cutaway section of FIG. 16 shows the engagement of the bolt U with the knob K. The bolt U is supported with a housing Y and by means of a pin V that may be secured in part by a cotter pin as illustrated in FIGS. 16 and 17. Also shown is a slot R that enables the bolt U to rotate into a position for engagement by the knob K. As indicated previously, there are four corner fasteners F and between each corner fastener there are additionally three other fasteners along each side edge of the lid L.

Reference is also now made to FIGS. 18 and 19 for disclosing the support bar A. The support bar A includes an elongated post A1 having at opposite ends thereof a small legs LE. The legs LE and the post A1 are meant to be secured in an inner wall surface S1 of the housing H. The post A1 extend across the port P1 as shown in FIG. 18.

One of the novel features of the fluid strainer of the present invention is having a basket with tapered ends as illustrated in FIG. 18. The basket B thus has an end at B1 with a width W1. The width W1 of the basket at that end is less than the length of the post A1 illustrated in FIG. 18 as dimension W2. If one were to attempt to insert the basket in the opposite direction, the larger end of the basket would engage against the ends LF of the legs LE and prevent the basket from being inserted into the housing. When the basket is inserted as in the position shown in FIG. 18, the other end of the basket will pass easily into the housing.

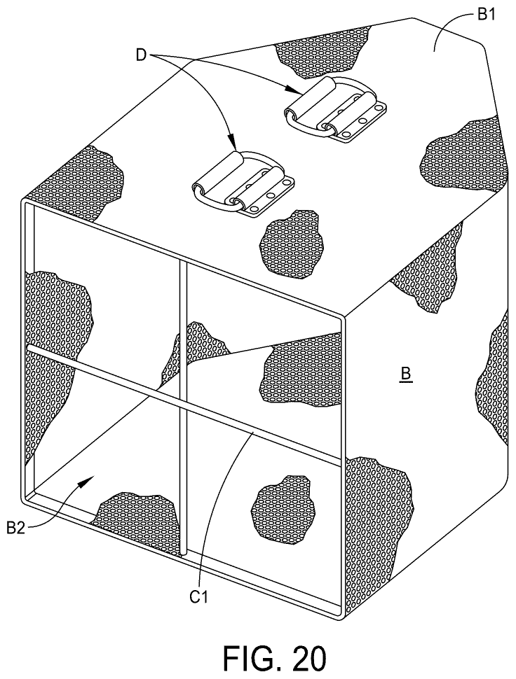

Reference is now also made to FIG. 20. This illustrates the use, at the input end of the basket B of a cross-piece C1 that bridges across the entire basket opening B2. This is for retaining any larger items that are captured during flow. Each of the four ends of the cross member C1 may be secured to an inner wall of the basket at the location illustrated in FIG. 20. FIG. 20 also illustrates the wall of the basket as having perforations. In another embodiment, the perforations may only be provided in the end tapered walls.

Having now described a limited number of embodiments of the present invention, it should now be apparent to those skilled in the art that numerous other embodiments and modifications thereof are contemplated as falling within the scope of the present invention, as defined by the appended claims.

1. A fluid strainer that is meant to remove debris from a fluid stream, comprising:
a housing having in inlet port defined at an inlet wall of the housing and an outlet port that is opposite to the inlet port and that is defined by an outlet wall of the housing;
said housing defining an interior chamber through which the fluid flows;
a strainer basket that is disposed within the housing chamber;
said strainer basket having an open inlet end into which the fluid flows from the housing inlet, opposed sidewalls including a pair of tapered outlet walls that merge and direct the fluid flow to the housing outlet port and an outlet end wall; and
a bar that is disposed within the housing that is located adjacent to and across the outlet port for spacing the outlet end wall of the strainer basket from the housing outlet wall.

2. The fluid strainer of claim 1 wherein the bar also has a pair of legs that support the bar at opposed sides of the outlet port.

3. The fluid strainer of claim 1 wherein the outlet end wall has a series of through-holes for the passage of fluid flow.

4. The fluid strainer of claim 3 wherein the tapered outlet walls also each include a series of through-holes.

5. The fluid strainer of claim 2 wherein each leg of the bar has one end that is secured to the housing outlet wall at opposed respective sides of the outlet port and a free end that extends from the bar and in the direction of the housing inlet wall.

6. The fluid strainer of claim 5 wherein the open inlet end of the strainer basket has a width that is greater than a length of the support bar so that the strainer basket can be engaged in the housing only where the open inlet end of the strainer basket is engaged with the inlet port of the housing.

7. The fluid strainer of claim 6 wherein the outlet end wall of the strainer basket contacts the support bar leaving a space between the outlet end wall of the strainer basket and an inner surface of the housing outlet wall so as to mitigate against turbulence.

8. The fluid strainer of claim 7 wherein the outlet end wall of the strainer basket has a width that is less than the length of the support bar.

9. The fluid strainer of claim 1 including a lid over the housing and a series of swivel clamps that secure the lid to the housing.

10. The fluid strainer of claim 9 wherein the series of swivel clamps include a plurality of swivel clamps along each of four sides of the housing.

11. The fluid strainer of claim 1 including a lid that is disposed over the housing and covering the interior chamber, a series of swivel clamps that secure the lid to the housing, a gasket that is disposed between the housing and the lid and a series of slots in the lid that accommodate selectively a clamp post of each swivel clamp.

12. The fluid strainer of claim 11 and further including a pneumatic apparatus coupled to the interior chamber to provide a firm seal at the gasket.

13. The fluid strainer of claim 1 including a reinforcing rib on a top surface of the lid.

14. The fluid strainer of claim 13 wherein the reinforcing rib is comprised of four orthogonal arranged ribs that each have a center opening so that the ribs form a handle for removing the lid.

15. A fluid strainer that is meant to remove debris from a fluid stream, comprising:
a housing having in inlet port defined at an inlet wall of the housing and an outlet port that is opposite to the inlet port and that is defined by an outlet wall of the housing;
said housing defining an interior chamber through which the fluid flows;
a strainer basket that is disposed within the housing chamber;
said strainer basket having an open inlet end into which the fluid flows from the housing inlet, opposed sidewalls including a pair of tapered outlet walls that merge and direct the fluid flow to the housing outlet port and an outlet end wall;
a lid over the housing and a series of swivel clamps that secure the lid to the housing.

16. The fluid strainer of claim 15 including a bar that is disposed within the housing that is located adjacent to and across the outlet port for spacing the outlet end wall of the strainer basket from the housing outlet wall.

17. The fluid strainer of claim 16 wherein the series of swivel clamps include a plurality of swivel clamps along each of four sides of the housing.

18. A fluid strainer that is meant to remove debris from a fluid stream, comprising:
a housing having in inlet port defined at an inlet wall of the housing and an outlet port that is opposite to the inlet port and that is defined by an outlet wall of the housing;
said housing defining an interior chamber through which the fluid flows;
a strainer basket that is disposed within the housing chamber;
said strainer basket having an open inlet end into which the fluid flows from the housing inlet, opposed sidewalls including a pair of tapered outlet walls that merge and direct the fluid flow to the housing outlet port and an outlet end wall; and
a reinforcing rib on a top surface of the lid.

19. The fluid strainer of claim 18 including a bar that is disposed within the housing that is located adjacent to and across the outlet port for spacing the outlet end wall of the strainer basket from the housing outlet wall.

20. The fluid strainer of claim 18 wherein the reinforcing rib is comprised of four orthogonal arranged ribs that each have a center opening so that the ribs form a handle for removing the lid.
